(19) United States
(12) Patent Application Publication
(10) Pub. No.: US 2018/0096699 A1
(43) Pub. Date: Apr. 5, 2018

(54) INFORMATION-PROVIDING DEVICE

(71) Applicant: HONDA MOTOR CO., LTD., Tokyo (JP)

(72) Inventors: Tomoko Shintani, Wako-shi (JP); Hiromitsu Yuhara, Wako-shi (JP); Eisuke Soma, Wako-shi (JP); Shinichiro Goto, Wako-shi (JP)

(73) Assignee: HONDA MOTOR CO., LTD., Tokyo (JP)

(21) Appl. No.: 15/720,191

(22) Filed: Sep. 29, 2017

(30) Foreign Application Priority Data
Sep. 30, 2016 (JP) 2016-194995

(51) Int. Cl. G10L 25/63; B60W 50/08; G10L 15/26

(52) U.S. Cl. CPC G10L 25/63; B60W 2040/089; G10L 15/26; B60W 50/08

(57) ABSTRACT

Provided is a device that identifies excitement in conversation among occupants of the vehicle and provides more appropriate information to the occupants at a better timing in accordance with a keyword which is expected to be of high interest for the occupants. A feeling estimation and determination unit estimates a feeling of an occupant in accordance with occupant state information acquired by an information acquisition unit. When the estimated feeling of the occupant corresponds to exaltation (excitement or the like), a target keyword designation unit designates a target keyword from keywords appearing during the past target time range and then outputs the target keyword. When a feeling of the occupant responding to the target keyword is positive, information associated with the target keyword is acquired and then output.

### CROSS REFERENCES TO RELATED APPLICATIONS

The present application claims priority under 35 U.S.C. § 119 to Japanese Patent Application No. 2016-194995, filed Sep. 30, 2016, entitled “Information-Providing Device.” The contents of this application are incorporated herein by reference in their entirety.

### TECHNICAL FIELD

The present disclosure relates to a device that performs communication, or facilitates a mutual understanding, between a driver of a vehicle and a computer in the vehicle.

### BACKGROUND

A technology that is able to determine a sense of excitement in a vehicle in accordance with a conversation among occupants and provide entertainment to the occupants is known (see, for example, Japanese Unexamined Patent Application Publication No. 2002-193150). In the related art, excitement is determined based on the amplitude of sound following analysis of audio data.

However, determination of excitement in a vehicle by relying on the amplitude of sound is systematic, and as a result, the timing of providing entertainment may not always be acceptable for the occupants. Further, the provided entertainment is set in advance and thus may not always be best suited to the conversation in the vehicle. By providing information newly obtained from a conversation, entertainment will be more suited to the conversation in the vehicle.

### SUMMARY

The present application describes a device that identifies excitement in a conversation among occupants of the vehicle and provides more appropriate information to the occupants at a better timing based on a keyword which is expected to be of high interest to the occupants.

One aspect of an information-providing device of the present disclosure is an information-providing device that provides information to an occupant of a vehicle. The information-providing device includes: a feeling estimation and determination unit that estimates the feeling (or the emotion) of an occupant in accordance with occupant state information indicating a state of the occupant; a target keyword designation unit that, when the feeling of the occupant estimated by the feeling estimation and determination unit corresponds to excitement, designates and then outputs a target keyword which appeared during the past target time range of a certain time period that before occurred the feeling of the occupant corresponds to excitement; and an information generating unit that, when the feeling of the occupant with respect to the target keyword estimated by the feeling estimation and determination unit corresponds to affirmation, acquires and then outputs information associated with the target keyword.

It is desirable that the information-providing device of the present disclosure further include a storage unit that associates the information output by the information generating unit with a feeling corresponding to a reaction of the occupant to the information estimated by the feeling estimation and determination unit and stores the information and the feeling. The information generating unit may determine new information in accordance with the information and the feeling corresponding to the reaction of the occupant associated with each other and stored in the storage unit.

According to the information-providing device of the present disclosure, for example, more appropriate information can be provided to occupants of a vehicle at a more suitable timing in view of a keyword that originates from the occupants and the feeling associated with the keyword.

### BRIEF DESCRIPTION OF THE DRAWINGS

The advantages of the disclosure will become apparent in the following description taken in conjunction with the following drawings.

FIG. 1 is a configuration diagram illustrating a fundamental system of an embodiment.

FIG. 2 is a configuration diagram illustrating an agent device of an embodiment.

FIG. 3 is a configuration diagram illustrating a mobile terminal device of an embodiment.

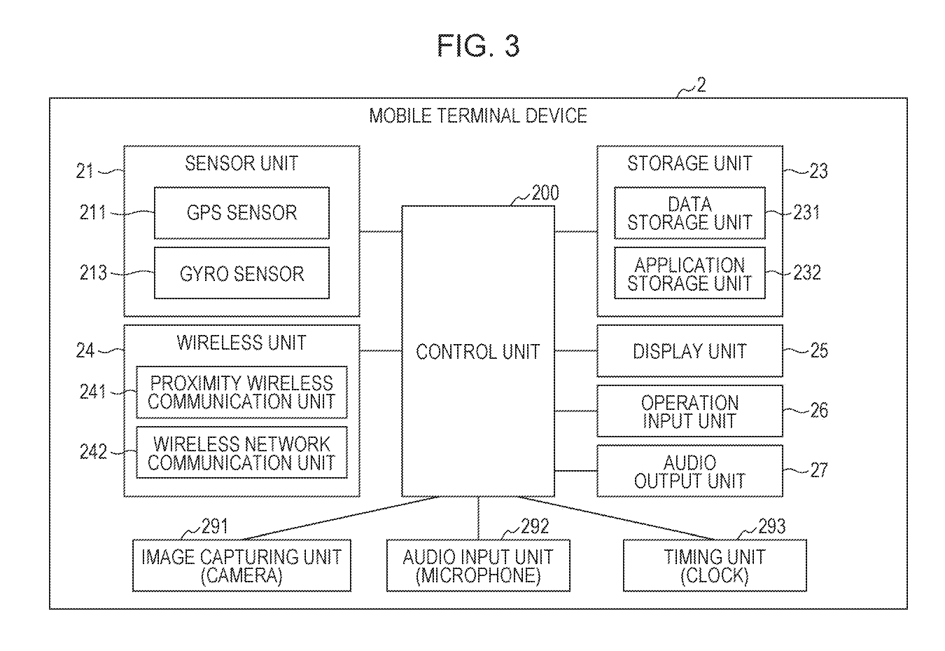

FIG. 4 is a configuration diagram illustrating an information-providing device as an embodiment of the present disclosure.

FIG. 5 is a functional diagram illustrating an information-providing device.

FIG. 6 is a diagram illustrating an existing plutchik model.

### DETAILED DESCRIPTION

### Configuration of Fundamental System

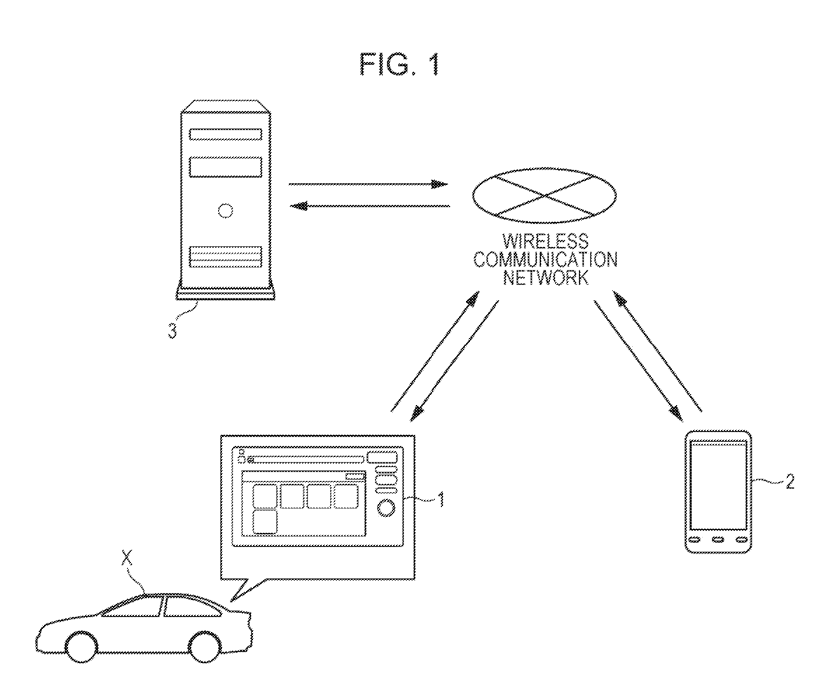

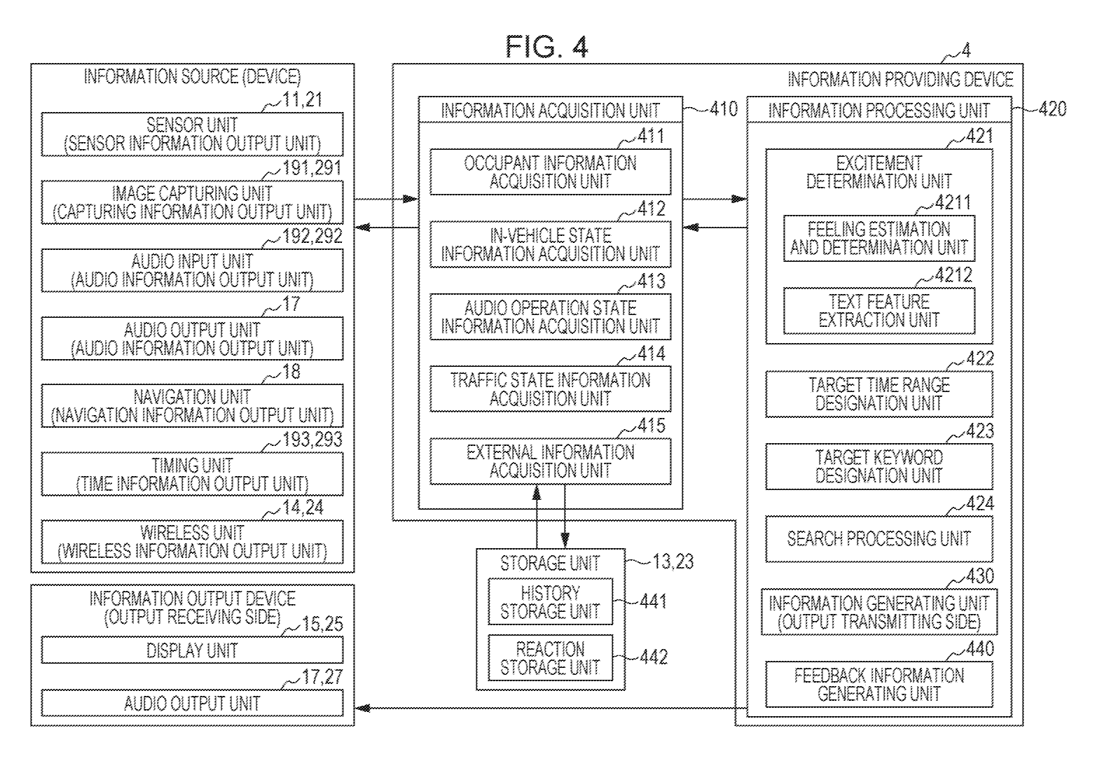

An information-providing device 4 (see FIG. 4) as an embodiment of the present disclosure is formed of at least some components of the fundamental system illustrated in FIG. 1. The fundamental system is formed of an agent device 1 mounted on a vehicle X (a mobile unit (or a moving entity)), a mobile terminal device 2 (for example, a smartphone) that can be carried in the vehicle X by an occupant, and a server 3. The agent device 1, the mobile terminal device 2, and the server 3 each have a function of wirelessly communicating with each other via a wireless (or radio) communication network (for example, the Internet). The agent device 1 and the mobile terminal device 2 each have a function of wirelessly communicating with each other by using a proximity wireless scheme (for example, Bluetooth (registered trademark) when these devices are physically close to each other, such as being present in, or within the vicinity of, the same vehicle X.

### Configuration of Agent Device

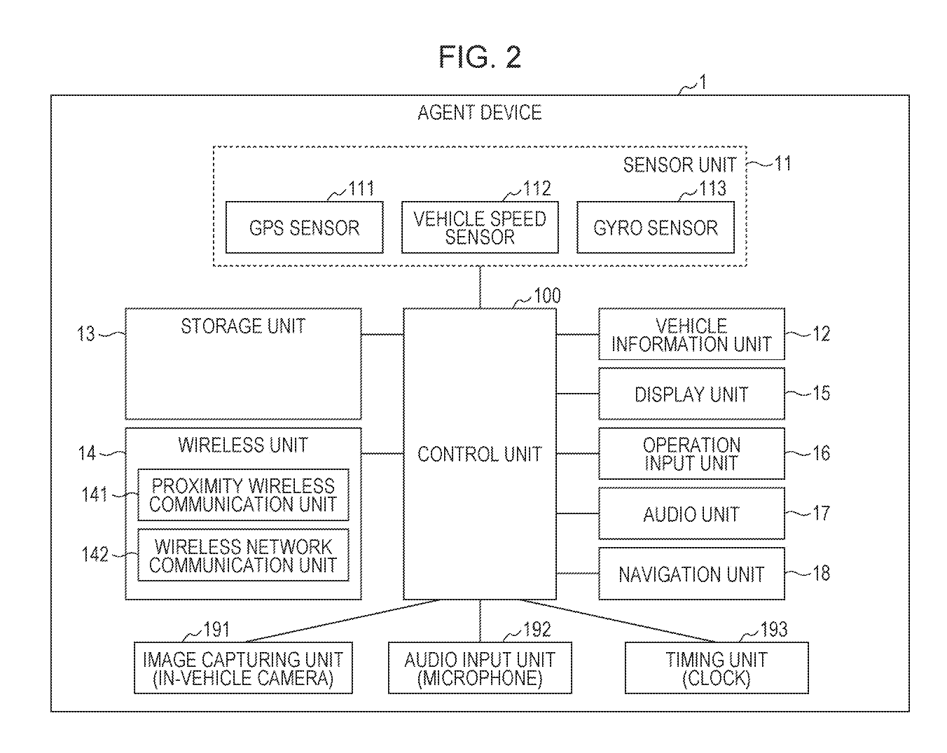

The agent device 1 has a control unit (or a controller) 100, a sensor unit 11 (that includes a global positioning system (GPS) sensor 111, a vehicle speed sensor 112, and a gyro sensor 113 and may include a temperature sensor inside or outside the vehicle, a temperature sensor of a seat or a steering wheel, or an acceleration sensor), a vehicle information unit 12, a storage unit 13, a wireless unit 14 (that includes a proximity wireless communication unit 141 and a wireless network communication unit 142), a display unit 15, an operation input unit 16, an audio unit 17 (an audio (or voice) output unit), a navigation unit 18, an image capturing unit 191 (an in-vehicle camera), an audio input unit 192 (a microphone), and a timing unit (a clock) 193, as illustrated in FIG. 2, for example. The clock may be a component which employs time information of a GPS described later.

The vehicle information unit 12 acquires vehicle information via an in-vehicle network such as a CAN-BUS (CAN). The vehicle information includes information on the ON/OFF states of an ignition switch, an operation state of a safety system (Advanced Driving Assistant System (ADAS), Antilock Brake System (ABS), an airbag, and the like), or the like. The operation input unit 16 senses an input operation, such as steering, that is useful for estimating (or presuming) a feeling (or emotion) of an occupant, an amount of depression of an accelerator pedal or a brake pedal, operation of a window or an air conditioner (a temperature setting or a measurement of the temperature sensor inside or outside the vehicle) in addition to operation of pressing a switch or the like. A storage unit 13 of the agent device 1 has a sufficient storage capacity for continuously storing voice data of occupants during driving of the vehicle. Further, various information may be stored on the server 3.

### Configuration of Mobile Terminal Device

The mobile terminal device 2 has a control unit 200, a sensor unit 21 (that has a GPS sensor 211 and a gyro sensor 213 and may include a temperature sensor for measuring the temperature around the terminal or an acceleration sensor), a storage unit 23 (a data storage unit 231 and an application storage unit 232), a wireless unit 24 (a proximity wireless communication unit 241 and a wireless network communication unit 242), a display unit 25, an operation input unit 26, an audio output unit 21, an image capturing unit 291 (a camera), an audio input unit 292 (a microphone), and a timing unit (a clock) 293. The clock may be a component which employs time information of a GPS described later.

The mobile terminal device 2 has components common to the agent device 1. While having no component that acquires vehicle information (see the vehicle information unit 12 of FIG. 2), the mobile terminal device 2 can acquire vehicle information from the agent unit 1 via the proximity wireless communication unit 241, for example. Further, the mobile terminal device 2 may have functions similar to the functions of the audio unit 17 and the navigation unit 18 of the agent device 1 according to an application (software) stored in the application storage unit 232.

### Configuration of Information-Providing Device

The information-providing device 4 as an embodiment of the present disclosure illustrated in FIG. 4 is formed of one or both of the agent device 1 and the mobile terminal device 2. The term “information” represents a concept that entails reflecting an atmosphere where a conversation occurs or a feeling of an occupant, information which is of high interest to an occupant, information which is expected to be useful to an occupant, and the like.

Some of the components of the information-providing device 4 may be the components of the agent device 1, the remaining components of the information-providing device 4 may be the components of the mobile terminal device 2, and the agent device 1 and the mobile terminal device 2 may cooperate with each other so as to complement each other's components. For example, by taking advantage of the fact that a relatively large storage capacity can be set in the agent device 1, information may be transmitted from the mobile terminal device 2 to the agent device 1, and a large amount of information may be accumulated in the agent device 1. The determination result and information acquired by the mobile terminal device 2 may be transmitted to the agent device 1, because the function of the application program of the mobile terminal device 2 may be updated relatively frequently or occupant information can be easily acquired at any time on a daily basis. Information may be provided by the mobile terminal device 2 in response to an instruction from the agent device 1.

A reference symbol N₁ (N₂) indicates being formed of or being performed by one or both of a component N₁ and a component N₂.

The information-providing device 4 includes the control unit 100 (200) and, in accordance with the operation thereof, may acquire realtime information or accumulated information from the sensor unit 11 (22), the vehicle information unit 12, the wireless unit 14 (24), the operation input unit 16, the audio unit 17, the navigation unit 18, the image capturing unit 191 (291), the audio input unit 192 (292), the timing unit (the clock) 193, and the storage unit 13 (23) if necessary, and may provide information (content) to the occupants via the display unit 15 (25) or the audio output unit 17 (27). Further, information necessary for ensuring optimal use of the information-providing device 4 by the occupants is stored in the storage unit 13 (23).

The information-providing device 4 has an information acquisition unit 410 and an information processing unit 420. The information acquisition unit 410 and the information processing unit 420 are, for example, implemented by one or more processors, or by hardware having equivalent functionality such as circuitry. The information acquisition unit 410 and the information processing unit 420 may be configured by a combination of a processor such as a central processing unit (CPU), a storage device, and an ECU (electronic control unit) in which a communication interface is connected by an internal bus, or a micro-processing unit (MPU) or the like, which execute computer program. Moreover, of these, some or all may be implemented by hardware such as a large scale integration (LSI) or an application specific integrated circuit (ASIC), or may be implemented by a combination of software and hardware. The storage unit 13 (23) has a history storage unit 441 and a reaction storage unit 442. The storage unit 13 (23) is implemented by read only memory (ROM) or random access memory (RAM), a hard disk drive (HDD), flash memory, or the like.

The information acquisition unit 410 includes an occupant information acquisition unit 411, an in-vehicle state information acquisition unit 412, an audio operation state information acquisition unit 413, a traffic state information acquisition unit 414, and an external information acquisition unit 415.

The occupant information acquisition unit 411 acquires information on occupants such as a driver of the vehicle X as occupant information in accordance with output signals from the image capturing unit 191 (291), the audio input unit 192 (292), the audio unit 17, the navigation unit 18, and a clock 402.

The occupant information acquisition unit 411 acquires information on occupants including the passenger of the vehicle X in accordance with signals output from the image capturing unit 191 (291), the voice input unit 192 (292), and the clock 402. The audio operation state information acquisition unit 413 acquires information on the operation state of the audio unit 17 as audio operation state information. The traffic state information acquisition unit 414 acquires traffic state information on the vehicle X by cooperating with the server 3 and the navigation unit 18.

A motion image which indicates movement of a occupant (in particular, a driver or a primary occupant (a first occupant) of the vehicle X) captured by the image capturing unit 131 (291), such as a view of the occupant periodically moving a part of the body (for example, the head) to the rhythm of music output by the audio output unit 17 may be acquired as occupant information. Humming performed by an occupant and sensed by the audio input unit 192 (292) may be acquired as occupant information. A motion image which indicates a reaction captured by the image capturing unit 191 (291) such as a change in the output image of the navigation unit 18 or motion of a line of sight of an occupant (a first occupant) in response to an audio output may be acquired as occupant information. Information on music information output by the audio unit 17 and acquired by the audio operation state information acquisition unit 413 may be acquired as occupant information.

The in-vehicle state information acquisition unit 412 acquires in-vehicle state information. A motion image which indicates movement of an occupant (in particular, a fellow passenger or a secondary passenger (a second occupants of the driver (the first occupant) of the vehicle X) captured by the image capturing unit 191 (291) such as a view of closing the eyes, a view of looking out of the window, a view of operating a smartphone, or the like may be acquired as in-vehicle state information. A content of a conversation between the first occupant and the second occupant or an utterance of the second occupant sensed from the audio input unit 192 (292) may be acquired as occupant information.

The traffic state information acquisition unit 414 acquires traffic state information. A traveling cost (a distance, a required traveling time, a degree of traffic congestion, or an amount of energy consumption) of a navigation route or roads included in the area covering the navigation route or a link of the roads transmitted to the information-providing device 4 from the server 3 may be acquired as traffic state information. A navigation route is calculated by the navigation unit 18 or the navigation function of the mobile terminal device 2 or the server 3 for a plurality of continuous links from the current location or a starting location to the destination location. The current location of the information-providing device 4 is measured by the GPS sensor 111 (211). The starting location and the destination location are set by an occupant via the operation input unit 16 (26) or the audio input unit 192 (292).

The information processing unit 420 has an excitement determination (or judgement) unit 421 (that includes a feeling estimation and determination unit 4211 and a text feature extraction unit 4212), a target keyword designation unit 423, a search processing unit 424, an information generating unit 430, and a feedback information generating unit 440.

The excitement determination unit 421 continuously acquires in-vehicle state information or primary information including the occupant conversation to identify presence or absence of excitement. The excitement determination unit 421 identifies a feeling of an occupant such as “like it very much” or “lovely” to identify excitement. Although no feature of a feeling is identified during an ongoing conversation between occupants, a state of “excitement” can be determined in accordance with the same keyword being repeated. The feeling estimation and determination unit 4211 estimates a feeling of an occupant in accordance with occupant state information that is at least one of the in-vehicle state information and the traffic state information acquired by the information acquisition unit 410. The text feature extraction unit 4212 extracts a feature of text indicating content uttered by an occupant. When the feeling of an occupant estimated by the feeling estimation and determination unit 4211 corresponds to exaltation (excitement or the like), the target keyword designation unit 423 outputs, via at least one of the display unit 15 (25) and the audio output unit 17 (27), the target keyword searched for by the search processing unit 424. When the feeling of an occupant with respect to the target keyword corresponds to affirmation (sympathy or the like), the information generating unit 430 acquires and then outputs, via at least one of the display unit 15 (25) and the audio output unit 17 (21), information on the target keyword. The information may be acquired from the storage unit 13 (23) or may be acquired from the server 3 via a wireless communication network. The feedback information generating unit 440 generates feedback information.

The storage unit 13 (23) stores, in association, the information output from the information generating unit 430 and a feeling corresponding to a reaction of an occupant to the information estimated by the feeling estimation and determination unit 4211. The information generating unit 430 determines new information in accordance with the information and the reaction feeling of the occupant that are associated with each other and stored in the storage unit 13 (23).

### Operation of Information-Providing Device

The operation or the function of the information-providing device 4 having the above configuration will be described.

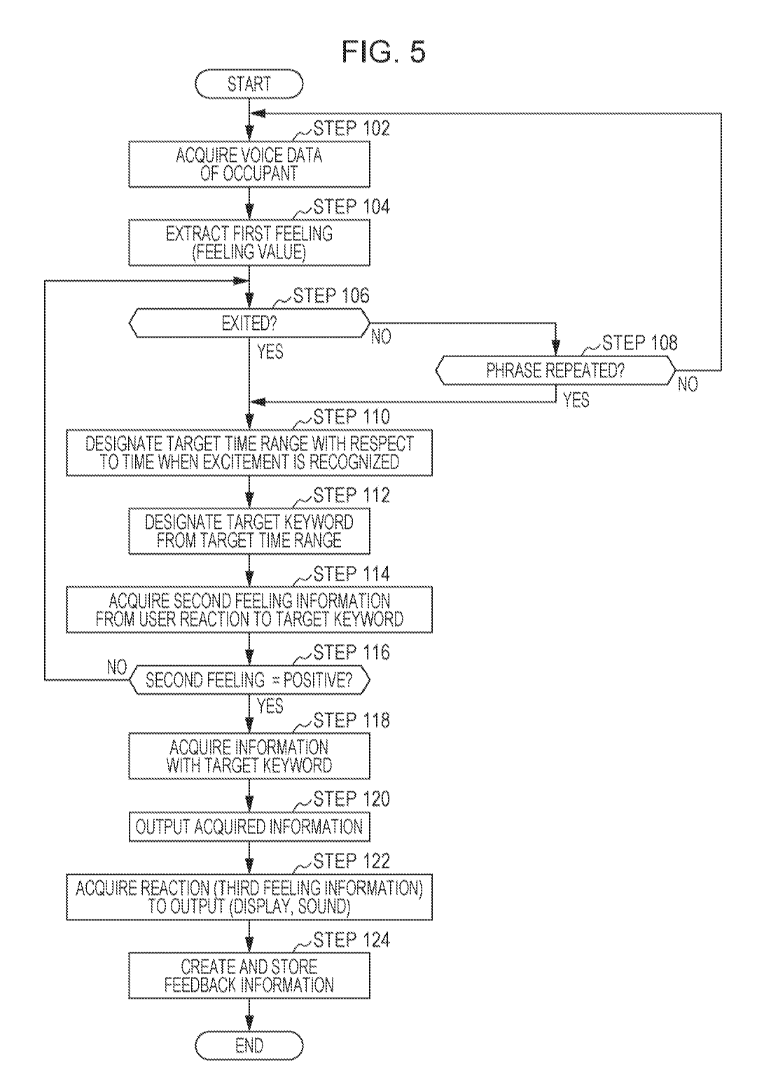

The information acquisition unit 410 acquires voice data or realtime data of an occupant of the vehicle X (FIG. 5, STEP 102). An utterance or a conversation of one or a plurality of occupants in a cabin of the vehicle X detected by the audio input unit 192 (292) is acquired as voice data.

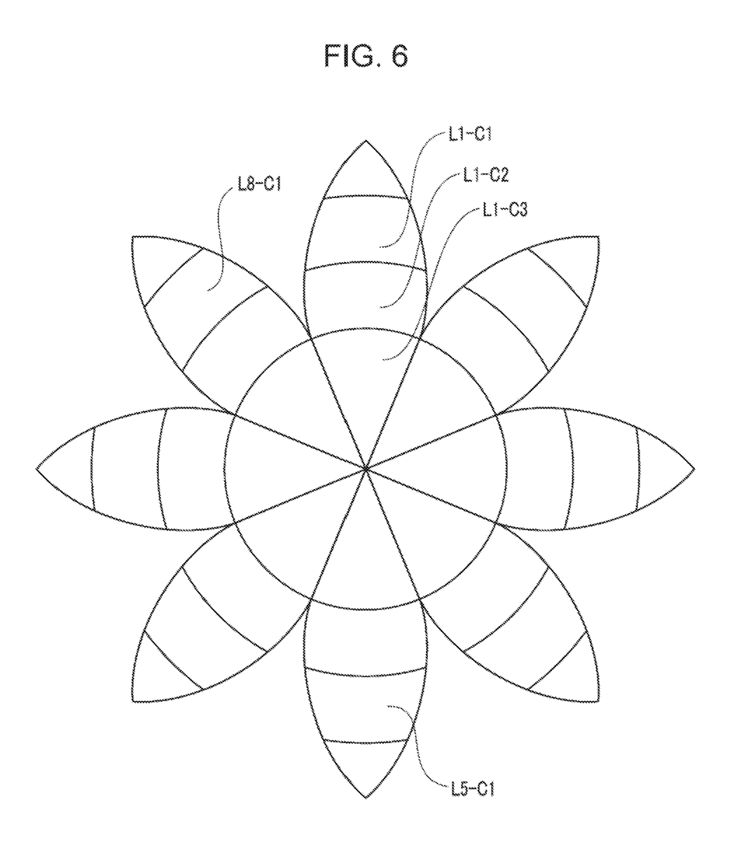

The feeling estimation and determination unit 4211 estimates or extracts a first feeling (a feeling value) of an occupant in accordance with occupant state information (first information) that is at least one of the occupant Information, the in-vehicle state information, and the traffic state information acquired by the information acquisition unit 410 (FIG. 5, STEP 104). Specifically, with the first information being input, a filter created by machine learning, such as deep learning, or by a support vector machine is used to estimate a feeling value of the occupant. For example, when the occupant state information Includes a motion image or voice data that indicates a view of a plurality of occupants enjoying a conversation, a high feeling value of the plurality of occupants is estimated. Estimation of a feeling may be performed in accordance with a known or otherwise novel emotion model (or emotion table). FIG. 6 schematically illustrates a known plutchik emotion model. Classification includes eight types each including four sets of feelings in which “joy”, “sadness”, “anger”, “fear”, “disgust”, “trust”, “surprise”, and “anticipation” are indicated in eight directions L1 . . . L5 to L8, and a stronger level of feeling is expressed in the areas closer (C1 to C3) to the center.

In accordance with information including a conversation between occupants of the vehicle X, the excitement determination unit 421 determines whether or not the feeling or the atmosphere of occupants in the vehicle X corresponds to excitement (FIG. 5, STEP 106). This process corresponds to a primary determination process for determining the presence or absence of excitement. For example, when it is estimated that the occupant has a feeling of “like it very much”, “lovely”, or the like in accordance with the content of a conversation between occupants, it is determined that the occupants are excited. Further, the determination of excitement can be applied to words spoken by a single occupant not directed to other occupants. The determination of affirmation may be based on text expressing affirmation such as “Yes”, “Oh yeah”, and “That's cool” interposing by multiple persons or alone or may be based on a laughing voice.

When the primary determination result is negative (FIG. 5, STEP 106, NO), the excitement determination unit 421 determines whether or not the same keyword or phrase extracted by the text feature extraction unit 4212 is repeated (a designated number of times or more) while no feature in the feeling is identified during an ongoing conversation between occupants (FIG. 5, STEP 108). This process corresponds to a secondary determination process for determining the presence or absence of excitement. When the same keyword or phrase is repeated, it is determined that the occupants are excited.

When it is determined that the occupants in the vehicle X are not excited (FIG. 5, STEP 106, NO or STEP 108, NO), the process on and after the acquisition of the voice data of the occupants is repeated (see FIG. 5, STEP 102, STEP 104, STEP 106, and then STEP 108).

On the other hand, when it is determined that the occupants in the vehicle X are excited (or the same keyword or phrase is repeated) (FIG. 5, STEP 106, YES or STEP 108, YES), the target keyword designation unit 423 determines the past certain time range (the length ranging from several seconds to several-ten seconds) occurring before the time when the occupants are excited. The past target time range of a certain time period (for example, one minute) before the time when the estimated feeling value above the threshold occurred is determined (FIG. 5, STEP 110). The target keyword designation unit 423 designates a target keyword from the keywords extracted from the voice data during the target time range and then outputs the target keyword via at least one of the display unit 15 (25) and the audio output unit 17 (27) (FIG. 5, STEP 112).

The information acquisition unit 410 acquires occupant state information indicating a state of the occupant when the occupant perceives a target keyword, and the feeling estimation and determination unit 4211 estimates a second feeling from a reaction of the occupant in accordance with the occupant state information (second information) (FIG. 5, STEP 114). Specifically, with the second information being input, a filter created by machine learning, such as deep learning, or by a support vector machine is used to estimate a feeling of the occupant. The estimation of a feeling may be performed in accordance with a known emotion model (see FIG. 6) or a novel emotion model. The second information may be the same as or different from the first information (see FIG. 5, STEP 106 that is an evaluation basis for a feeling value.

For example, when the second information includes voice data including a positive keyword such as “that's great”, “agree”, or “let's give it a try”, the reacting feeling of the occupant is more likely to be estimated as positive. In contrast, when the second information includes voice data including a negative keyword such as “not quite”, “disagree”, or “I'll pass this time”, the reacting feeling of the occupant is more likely to be estimated as negative.

The information generating unit 430 determines whether or not the second feeling of the occupant to the target keyword estimated by the feeling estimation and determination unit 4211 corresponds to affirmation (sympathy or the like) (FIG. 5, STEP 116). When it is determined that the second feeling of the occupant does not correspond to affirmation such as corresponding to denial (FIG. 5, STEP 116, NO), the process on and after the determination of presence or absence of excitement is repeated (see FIG. 5, STEP 106 to STEP 116). On the other hand, when it is determined that the second feeling of the occupant corresponds to affirmation (FIG. 5, STEP 116, YES), the information generating unit 430 acquires information associated with the target keyword (FIG. 5, STEP 118). Such information may be searched from an external information source each time. In this case, the external information frequently obtained (automatically transmitted) from the external information source may be temporarily stored in the storage unit 13 (23), and information may be selected therefrom. The information generating unit 430 outputs this information via at least one of the display unit 15 (25) and the audio output unit 17 (27) (FIG. 5, STEP 120). This output information is provided as “information suitable for a content of a conversation between occupants of the vehicle X” or “information suitable for an atmosphere of occupants of the vehicle X”.

The information acquisition unit 410 acquires occupant state information indicating a state of the occupant when the occupant perceives the information, and the feeling estimation and determination unit 4211 estimates a third feeling from a reaction of the occupant in accordance with the occupant state information (third information) (FIG. 5, STEP 122). Specifically, with the third information being input, a filter created by machine learning, such as deep learning, or by a support vector machine is used to estimate a feeling of the occupant. The estimation of a feeling may be performed in accordance with a known emotion model (see FIG. 6) or a novel emotion model. The third information may be the same as or different from the first information that is an evaluation basis for a feeling value (see FIG. 5, STEP 106) and the second information.

The feedback information generating unit 440 then stores the output information and the corresponding third feeling of the occupant associated with each other in the storage unit 13 (23) (FIG. 5, STEP 124). The information generating unit 430 can determine a new target keyword or information corresponding thereto in accordance with the information and the reacting feeling of the occupant associated with each other and stored in the storage unit 13 (23) (see FIG. 5, STEP 112 and STEP 118).

### Function of Information-Providing Device (Modified Example)

In another embodiment, after a keyword is extracted, information in accordance with the keyword may be acquired by the information generating unit 430, and the keyword and information may be associated with each other and stored in the storage unit 13 (23). When the second feeling of the occupant to the target keyword is determined to be positive (see FIG. 5, STEP 116, YES), the information associated with the target keyword may be read from the storage unit 13 (23) and output via at least one of the display unit 15 (25) and the audio output unit 17 (27) (see FIG. 5 STEP 120).

### Advantage

According to the information-providing device 4 of the present disclosure, more appropriate information can be provided to occupants of a vehicle at a more suitable timing in view of a keyword that originates from the occupants and the feeling associated with the keyword. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

We claim:

1. An information-providing device that provides information to an occupant of a vehicle, the information-providing device comprising:
a feeling estimation and determination controller configured to estimate a feeling of the occupant by using occupant state information indicating a state of the occupant;
a target keyword designation controller configured to determine, when the feeling of the occupant estimated by the feeling estimation and determination controller corresponds to excitement, designates and then outputs a target keyword which appeared in voice data of the occupant during the past target time range of a certain time period occurred before a time when the feeling of the occupant is determined to correspond to the excitement; and
an information generating controller configured to determine whether the feeling of the occupant responding to the outputted target keyword is estimated by the feeling estimation and determination controller to be positive feeling, and if so, acquires and then outputs information associated with the target keyword.

2. The information-providing device according to claim 1, further comprising
a storage device that associates the information output by the information generating controller with a reaction feeling corresponding to a reaction of the occupant to the information, the reaction feeling being estimated by the feeling estimation and determination controller, and stores the information and the reaction feeling in association with each other,
wherein the information generating controller determines new information by using the information and the reaction feeling of the occupant that are associated with each other and stored in the storage device.

3. A mobile unit comprising the information-providing device according to claim 1.

4. The information-providing device according to claim 1, wherein the feeling estimation and determination controller determines that the feeling of the occupant corresponds to excitement when the same keyword or phrase is repeated in the voice data of the occupant.

5. The information-providing device according to claim 1, wherein the information is an information suitable for a content of a conversation of the occupant of the vehicle, or an information suitable for an atmosphere of occupant of the vehicle.

6. An information-providing method that provides information to an occupant of a vehicle, the method being executed by a computer and comprising steps of:
(i) estimating a feeling of the occupant by using occupant state information indicating a state of the occupant;
(ii) determining whether the feeling of the occupant estimated by the step (i) corresponds to excitement, and if so, designating and then outputting a target keyword which appeared in voice data of the occupant during the past target time range of a certain time period occurred before a time when the feeling of the occupant is determined to correspond to the excitement; and
(iii) determining whether the feeling of the occupant responding to the outputted target keyword is positive feeling, and if so, acquiring and then outputting information associated with the target keyword.

7. A non-transitory computer readable medium storing an information-providing program that provides information to an occupant of a vehicle and that causes a computer to execute processing comprising steps of:
(i) estimating a feeling of the occupant by using occupant state information indicating a state of the occupant;
(ii) determining whether the feeling of the occupant estimated by the step (i) corresponds to excitement, and if so, designating and then outputting a target keyword which appeared in voice data of the occupant during the past target time range of a certain time period occurred before a time when the feeling of the occupant is determined to correspond to the excitement; and
(iii) determining whether the feeling of the occupant responding to the outputted target keyword is positive feeling, and if so, acquiring and then outputting information associated with the target keyword.
